(19) United States
(12) Patent Application Publication
(10) Pub. No.: US 2011/0010379 A1
(43) Pub. Date: Jan. 13, 2011

(54) DATABASE SYSTEM WITH QUERY INTERCEPTION AND REDIRECTION

(75) Inventors: Ilia GILDERMAN, Jerusalem (IL); Moshe Elisha, Lapid (IL); Avi Vigder, Petach-Tikva (IL); Yaniv Romem, Jerusalem (IL); Guy Nir, Rishon-LeZion (IL); Assaf Talyosef, Kiryat-Ono (IL)

Correspondence Address: MARTIN D. MOYNIHAN d/b/a PRTSI, INC., P.O. BOX 16446, ARLINGTON, VA, 22215, US

(73) Assignee: Xeround Systems Ltd., Yahud (IL)

(21) Appl. No.: 12/832,138

(22) Filed: Jul. 8, 2010

Related U.S. Application Data
(60) Provisional application No. 61/224,084, filed on Jul. 9, 2009.

(51) Int. Cl. G06F 17/30

(52) U.S. Cl. 707/759; 707/769; 707/E17.014

(57) ABSTRACT

A database system includes: a first database having back-end functionality for data storage and database query execution, a database front-end and an interception unit. The database front-end is configured for processing user queries directed to a back-end of a second database, and lacks the capabilities for directly accessing the first database. The interception unit is networked with the first database over a data network, and is configured for monitoring user queries under processing by the front-end to identify queries pertaining to data stored in the first database, and redirecting the identified queries to the first database for execution. Thereby the functionality of the database front-end is provided for data stored in the first database.

### RELATED APPLICATION

This application claims the benefit of priority under 35 USC 119(e) of U.S. Provisional Patent Application No. 61/224,084 filed Jul. 9, 2009, the contents of which are incorporated herein by reference in their entirety.

### FIELD AND BACKGROUND OF THE INVENTION

The present invention, in some embodiments thereof, relates to a database system with query interception capabilities and, more particularly, but not exclusively, to a database system utilizing query interception to enable interaction between a local front-end and an external database.

A database is an organized collection of data. Databases are typically managed by a database management system (DBMS) which organizes the storage of data and performs other functions such as the creation, maintenance, and usage of the database storage structures. Databases also provide users with a user interface and front-end that enables the users to query the database, often in complex manners which require processing and organization of the data.

One significant problem that may arise is that data stored in one database system may not be accessible by a different database system. Different databases are often not compatible even if they utilize the same data model and/or query language. Additionally, the local database interfacing directly with the user may not have the proper capabilities and/or configuration to operate in concert with a second database. As a result, users cannot take advantage of the benefits of both database systems by building a multi-tiered system which suits their needs.

Currently there are databases which support operation with multiple back-ends by including internal redirection logic. In other existing databases, such as MySQL, multiple back-ends may be installed for the local front-end, with static redirection to one or more of the installed back-ends. In both cases, the local front-end lacks the capabilities for interacting with other back-ends which are not accounted for by internal front-end logic.

Oracle is a relational database management system (RDBMS) produced and marketed by Oracle Corporation. Oracle is one of the most widely used databases (or RDBMS) today. Oracle does provide some back-end support for other databases or other data sources with the Oracle Data Cartridge Interface with its Heterogeneous Services back-end interface. However, the Heterogeneous Services back-end interface does not support full Oracle compatible syntax and does not support Oracle stored procedure computation inside the Oracle system. Other databases, which may be superior to Oracle in some aspects, may therefore not be able to interface with Oracle in a manner that is indiscernible to the user.

U.S. Pat. No. 7,693,913 by Goto presents a compiler, which makes a computer carry out a process for generating a program used for a remote access to a virtual database, and virtualizing native databases as one database. Goto describes a first computer furnished with an application program receiving a prescribed input parameter from a user, and a second computer which is connected to the first computer by way of a network and which includes one or more databases. The program makes the computer execute an RPC replacement process for replacing a description part relating to a data manipulation language (DML) execution process for the virtual database from a source code of the application program with a description relating to a remote procedure call (RPC) process, and a native DML execution program generation process for generating a native DML execution program that is a program for executing a DML execution process for the native databases based on the RPC process.

### SUMMARY OF THE INVENTION

Embodiments herein enable a user utilizing a given database front-end (denoted herein the local front-end) to access data in a second database (denoted herein the external database), even though the local front-end lacks the capabilities to access the external database directly.

There are many possible reasons for the limitation on the local front-end's ability to access the external database. In some cases the local front-end does not have a mechanism for interacting with the required external database (e.g. does not have the internal logic for directing queries to the external database). Other reasons may include incompatibilities of the database language, schema, data model (e.g. relational vs. non-relational) or other system aspects. Another possible reason is database configuration. The local front-end may not be configured to operate with the needed external database, regardless of whether the local front-end and the external database are inherently compatible, for example due to the absence of internal redirection logic which includes the external database. As used herein, the phrase a front-end which lacks capabilities for directly accessing an external database means any front-end which does not have direct access to some or all of the external database stored data and/or other functionality.

The present embodiments provide a database engine, database system and method for accessing data from a database which intercepts queries being processed by a local front-end. Queries which relate to data stored in an external database are intercepted, and are redirected to the external database. A path is thus established for interaction with the external database, even thought the local front-end may lack the capabilities (e.g. configuration) to interact with the external database directly. Incompatibilities between the local and external databases may be overcome by a translation process, which translates identified queries into corresponding queries which are appropriate for the external database.

The user is thus able to enjoy the benefits of both the local front-end and the data storage and processing capabilities of the external database.

According to an aspect of some embodiments of the present invention there is provided a database system which includes: a first database having back-end functionality for data storage and database query execution; a database front-end configured for processing user queries directed to a back-end of a second database, wherein the database front-end lacks capabilities for directly accessing the first database; and an interception unit associated with the front-end and networked with the first database over a data network, configured for monitoring user queries under processing by the front-end to identify queries pertaining to data stored in the first database, and redirecting the identified queries to the database for execution, thereby to provide the functionality of the database front-end for data stored in the first database.

According to some embodiments of the invention, the interception unit is further configured for receiving results of the redirected queries returned by the first database.

According to some embodiments of the invention, the interception unit is configured to monitor back-end data access resulting from a user query and to determine whether the back-end data access pertains to data stored in the first database.

According to some embodiments of the invention, the interception unit is configured to monitor data index access resulting from a user query and to determine whether the data index access pertains to data stored in the first database.

According to some embodiments of the invention, the interception unit is configured to monitor data element definition queries resulting from a user query and to determine whether the data element definition queries pertain to data stored in the first database.

According to some embodiments of the invention, the interception unit is configured to monitor transaction conclusions and to determine whether the transaction conclusions pertain to data stored in the first database.

According to some embodiments of the invention, the database system further includes a translation unit configured for translating an identified query into a corresponding query appropriate for execution by the first database.

According to some embodiments of the invention, the translation unit is configured to resolve incompatibilities between the first database and the database front-end so as to translate the identified query into a query executable by the first database.

According to some embodiments of the invention, the database system further includes a translation table configured for storing translated queries, and arranged for storage such that the processing of a user query by the front-end retrieves a corresponding translated query from the translation table.

According to some embodiments of the invention, the translation unit includes a local data store configured for storing the translation table.

According to some embodiments of the invention, the first database includes a relational database having stored data organized as a table, wherein each row of the table includes a relation of attribute values, and wherein the translation table is organized as a table of function calls such that accessing a location in the translation table prompts a function call to the corresponding translated query.

According to some embodiments of the invention, the first database further includes front-end functionality for processing user queries directed to the database.

According to some embodiments of the invention, the second database includes a single database back-end.

According to some embodiments of the invention, the second database includes a distributed database back-end.

According to some embodiments of the invention, the database system further includes a third database having back-end functionality for data storage and database query execution, wherein the database front-end lacks capabilities for directly accessing the third database, and wherein the interception unit is further networked with the third database over a data network, the interception unit being further configured for monitoring user queries under processing by the front-end to identify queries pertaining to data stored in the third database and for selecting one of the first and third databases for redirection of an identified query.

According to an aspect of some embodiments of the present invention there is provided a database engine on an electronic processor, the database engine includes: an execution unit, configured for processing user queries; a user interface associated with the execution unit, configured for inputting user queries and providing the queries to the execution unit for processing; and an interception unit associated with the execution unit, configured for monitoring queries being processed by the execution unit to identify queries pertaining to data stored in an external database, wherein the execution unit lacks capabilities for directly accessing data stored in the external database, and redirecting the identified queries for execution by the external database.

According to some embodiments of the invention, the interception unit is configured to monitor back-end data access resulting from a user query and for determining whether the back-end data access pertains to data stored in the external database.

According to some embodiments of the invention, the interception unit is configured to monitor data index access resulting from a user query and for determining whether the data index access pertains to data stored in the external database.

According to some embodiments of the invention, the interception unit is configured to monitor data element definition queries resulting from a user query and for determining whether the data element definition queries pertain to data stored in the external database.

According to some embodiments of the invention, the interception unit is configured to monitor transaction conclusions and for determining whether the transaction conclusions pertain to data stored in the external database.

According to some embodiments of the invention, the interception unit is further configured for translating the identified queries into respective corresponding queries for execution by the external database, and for providing the translated queries to the external database.

According to some embodiments of the invention, the interception unit and the external database are configured for communication over a network.

According to an aspect of some embodiments of the present invention there is provided a method for accessing data from a database, the method including: inputting a query and initiating processing of the query by a first database; monitoring the processing to determine if the query pertains to data stored in a second database, wherein the first database lacks capabilities for directly accessing data stored in the second database; and if the query pertains to data stored in the second database, redirecting the query to the second database for execution.

According to some embodiments of the invention, the method further includes: receiving a result of the query from the second database; and completing processing of the query in accordance with the result.

According to some embodiments of the invention, the redirected query is incompatible with the second database, and the method further includes translating the redirected query into a corresponding query compatible with the second database.

According to some embodiments of the invention, the translating includes retrieving the corresponding query from a translation table, the translation table being organized such that the retrieving prompts a function call to the second database in accordance with the corresponding translated query.

According to some embodiments of the invention, the method further includes translating a result of the query compatible with the second database into a corresponding result suitable for further processing.

According to some embodiments of the invention, the monitoring includes determining whether a back-end data access pertains to data stored in the second database.

According to some embodiments of the invention, the monitoring includes determining whether a data index access pertains to data stored in the second database.

According to some embodiments of the invention, the monitoring includes determining whether a data element definition query pertains to data stored in the second database.

According to some embodiments of the invention, the monitoring includes determining whether a transaction conclusion pertains to data stored in the second database.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified block diagram of a database system, according to an embodiment of the present invention;

FIG. 1B is a simplified block diagram of a database system, according to an second embodiment of the present invention;

FIG. 2 is a simplified database table, according to an exemplary embodiment of the present invention;

FIG. 3 is a simplified database view, according to an exemplary embodiment of the present invention;

FIG. 4 is a simplified block diagram of a database engine on an electronic processor, according to an embodiment of the present invention;

FIG. 5 is a simplified flowchart of a method for accessing data from a database, according to an embodiment of the present invention; and

FIG. 6 is a simplified flowchart of a method for accessing data from a database, according to an exemplary embodiment of the present invention.

### DESCRIPTION OF SPECIFIC EMBODIMENTS OF THE INVENTION

The present invention, in some embodiments thereof, relates to a database system with query interception capabilities and, more particularly, but not exclusively, to a database system utilizing query interception to enable interaction between a local front-end and an external database.

Many database systems are available today. Database systems vary from one another in many ways. For example, database management systems are usually categorized according to the database model that they support, such as the network, relational or object model. The query language used to access data may also vary.

In many cases different database systems are not compatible with each other. This creates difficulties for users interested in using both database systems in a cohesive manner. Even if the database systems are of the same type or are otherwise fully compatible, the local database may not be configured for operation with a given external database and/or the user may wish to prevent the local database from directly accessing data stored in a different database.

As used herein the term database (also denoted a database system) means a system for storing data and for querying the stored data. As used herein, the term local front-end means the database component(s) having a user interface for inputting user queries and initial query processing capabilities. As used herein, the term external database means a database which is networked to the local database, with separate data store and query processing capabilities.

As used herein, the terms “local” and “external” are intended only to distinguish between the front-end and the database for which the interaction is being established via the interception and redirection mechanism, and do not impose any further limitations.

Embodiments below enable accessing data stored in an external database utilizing the user interface and some execution capabilities of a local front-end, while limiting direct access by the local front-end to the data stored in the external database. The user may thus take advantage of the benefits of both the local front-end and external database working together cohesively. The differences in interfaces and functionality may be indiscernible to applications not seeking to specifically decipher whether the data is being obtained from an external database.

For clarity, the following presents exemplary embodiments in which data stored in the external database is accessed only from the local database, using the full user interface capabilities of the local database. However, the claimed embodiments are not limited to the exemplary embodiments described herein. Other embodiments include hybrid database systems in which only portions of the external database stored data and/or execution are inaccessible by the local front-end. Yet other embodiments may include front-end capabilities in the external database.

As used herein the term external query means a query pertaining to data stored in an external database. As used herein the term local query means a query pertaining to data stored in a database directly accessible by the local front-end.

### Database System

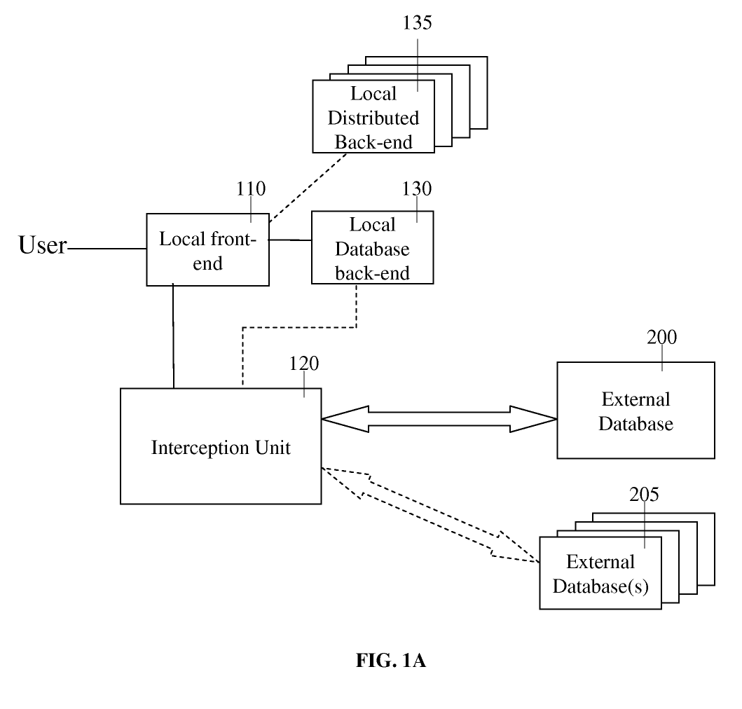

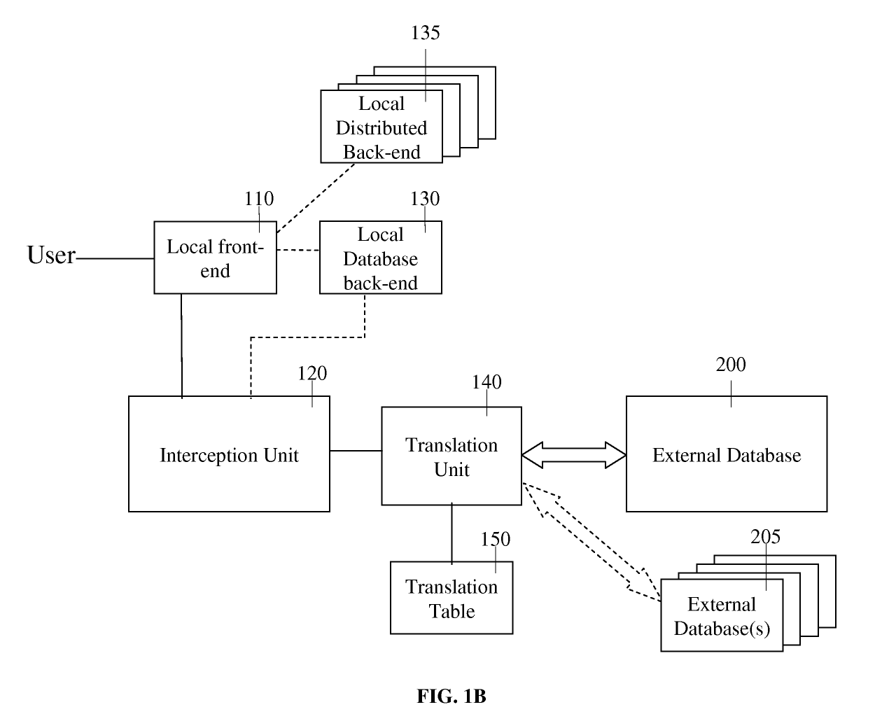

Reference is now made to FIGS. 1A and 1B, which are simplified block diagrams of a database system, according to a first and a second embodiment of the present invention respectively. The database system includes local front-end 110, interception unit 120.

Local front-end 110 includes a user-interface which serves for inputting user queries. Local front-end 110 also performs preliminary processing of the input queries prior to conveying the query to a database back-end for execution. Local front-end 110 may include other features known in the art such as language parsing, tokenizer, building the execution plan and invoking the back-end for further query processing.

Interception unit 120 monitors queries being processed by a local front-end 110 and identifies external queries. The identified external queries are intercepted and redirected to external database 200. In some embodiments interception unit 120 redirects the intercepted queries to external database 200 via translation unit 140 (as shown in FIG. 1B and described below). External database 200 processes the redirected (and possibly translated) queries. In some embodiments interception unit 120 intercepts all queries being processed. Local queries are not redirected, and resume processing by the local back-end.

In some embodiments, the results of the processing are returned to interception unit 120, and interception unit 120 forwards the query results to front end 110 for further processing to for provision to the user.

In some embodiments interception unit 120 is networked to at least one additional external database (205), and includes internal logic for selecting one of the multiple external databases for redirection of the intercepted query.

Monitoring of queries by interception unit 120 may be performed at one or more stages in the query processing process, including during invocation of a back-end by local front end 110 for query resolution.

Examples of monitoring operations include one or more of the following:

1) Monitoring back-end data access resulting from a user query to determine whether the back-end data access pertains to data stored in external database 200,

2) Monitoring data index access resulting from a user query to determine whether the data index access pertains to data stored in external database 200,

3) Monitoring data element definition queries resulting from a user query to determine whether the data element definition queries pertain to data stored in external database 200, and

4) Monitoring transaction conclusions to determine whether the transaction conclusions pertain to data stored in external database 200.

In some embodiments, local front-end 110 is configured to operate with a single dedicated local back-end 130 or local distributed back-end 135. Local queries which are not intercepted by interception unit 120 are directed by local front-end 110 to local back-end 130 or local distributed back-end 135. In some embodiments, interception unit 120 also performs monitoring and interception of queries being processed by the local back-end(s) (130 and/or 135).

In some embodiments, external database 200 performs the complete processing of the redirected query and returns the final result to interception unit 120. The final result is provided to the user with no additional processing. In other embodiments, local front-end 110 performs pre-processing of the query prior to its interception by interception unit 120 and/or post-processing of data returned by external database 200. Post-processing may be used to optimize the results provided to the user, for example by continuing the query processing with additional data. For example, the external query may trigger additional queries which are inferred locally and/or via another database back-end, or analyzing data returned by external database 200.

In some embodiments front-end 110 and external database 200 are incompatible, for example due to differing data models, query languages and/or protocols. The embodiments of FIG. 1B bridge these differences by translating queries, and possibly query results, which are compatible with one end of the system into a corresponding query or result compatible with the second end of the system.

In the embodiment of FIG. 1B, interception unit 120 redirects the intercepted queries to external database 200 via translation unit 140. Translation unit 140 translates the redirected query into a corresponding query executable by the external database 200. Translation unit 140 may further translate a query result returned by external database 200 into a corresponding result which is appropriate for further processing by database front-end 110 or local back-end 130.

Translation unit 140 may translate one or more of the following:

1) Query syntax;

2) Data structure or schema;

3) Data storage mechanism;

4) Database model (e.g. relational, object-based, key-value store); and

5) Calculations required before and/or after retrieving data.

In some embodiments, translation unit 140 accesses translation table 150 which stores the corresponding queries in a query format suitable for external database 200. When an identified query is provided to translation unit 140, translation unit 140 retrieves the corresponding query from translation table 150. The retrieved query is sent to external database 200. Since the retrieved query is compatible with external database 200, the appropriate externally-stored data item is returned to interception unit 120.

The manner in which translation table 150 is structured may be dependent upon the database model utilized by external database 200. Some databases utilize a relational model for data storage and query processing. According to the relational model, stored data is organized in a table format, with rows of relations (tuples), each row holding explicit values in the column positions (attributes). In an exemplary embodiment, external database 200 is a relational database with one or more tables. For each table in relational database 200, a corresponding view having the same name as the external database table is created and stored in translation table 150. The columns of the view are functions calls, which are prompted when the given relation is accessed by translation unit 140 from translation table 150.

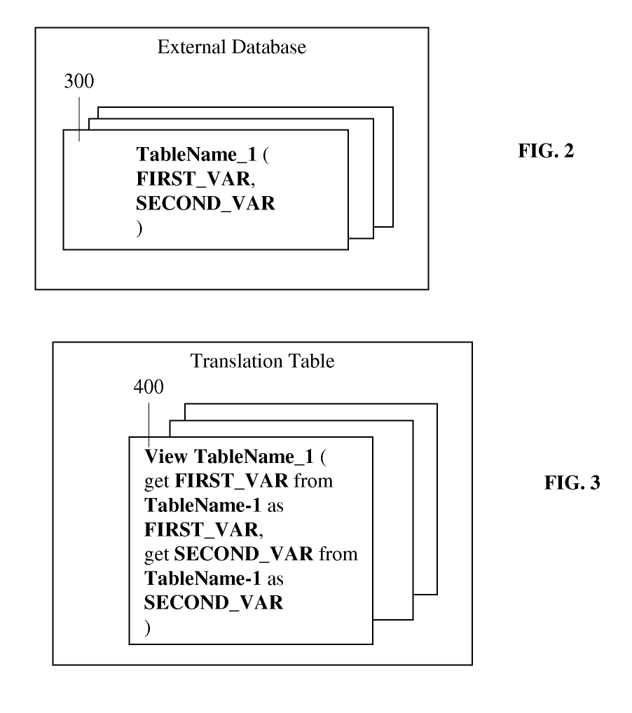

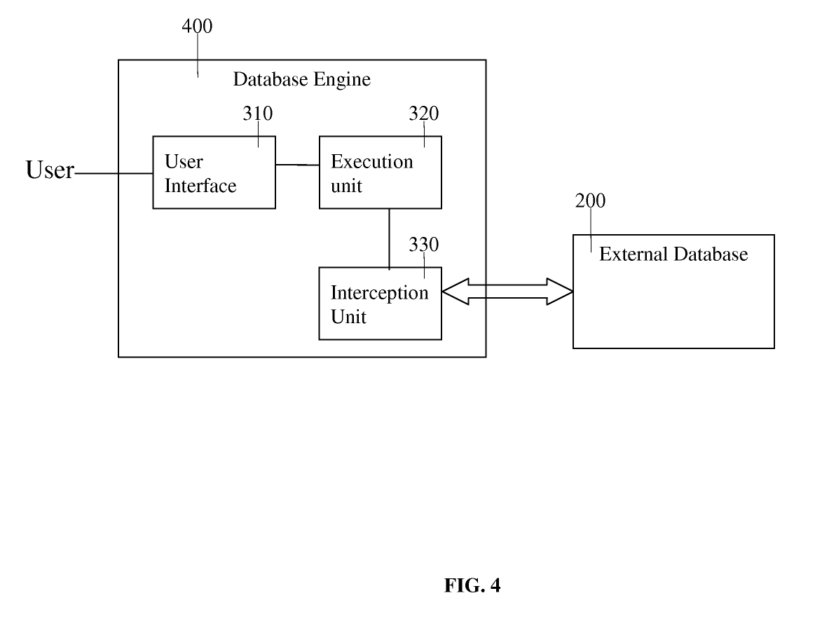

Reference is now made to FIGS. 3-4 which show a simplified example of an external database table 300 and the corresponding view 400. Given external database having a table 300 defined as follows:

TABLE 1

| | |
|---|---|
| 1. | create table TableName_1 ( |
| 2. | FIRST_VAR, |
| 3. | SECOND_VAR |
| 4. | ) |

A corresponding view 400 is created in translation table 150:

View 1

| | |
|---|---|
| 1. | create view TableName_1 as ( |
| 2. | get FIRST_VAR from TableName_1 as FIRST_VAR, |
| 3. | get SECOND_VAR from TableName_1 as SECOND_VAR |
| 4. | ) |

In the present example, translation unit 140 routes the identified queries to the view 500, which prompts function calls as defined in the view. The prompted function calls interact with external database 200 to retrieve the data stored in table 300, thus dynamically providing the data required for processing the user query which generated the function call.

In some embodiments multiple front-ends share a common external database thus creating a distributed, scalable and highly-available database system. In an exemplary embodiment, external database 200 is networked to a second database front-end via a second interception unit (and possibly translation unit). The functionality of the second database front-end database may differ from the front-end functionality of database front-end 110.

### Database Engine

Reference is now made to FIG. 4 which is a simplified block diagram of a database engine operating on an electronic processor, according to an embodiment of the present invention. Database engine 400 includes user interface 310, execution unit 320, and interception unit 330.

User interface 310 inputs user queries and provides the queries to the execution unit 320 for processing. Interception unit 330 monitors queries being processed by execution engine 320 in order to identify queries pertaining to data stored in external database 200. Identified queries are redirected to external database 400 for processing. Results returned by external database 200 are forwarded by interception unit 330 to execution unit 320 for any necessary further handling.

Functions monitored by interception unit 330 may include one or more of: back-end data access, data index access, data element definition and transaction conclusions

In some embodiments interception unit 330 redirects the identified queries via a translation unit operating substantially as described above.

### Data Access Method

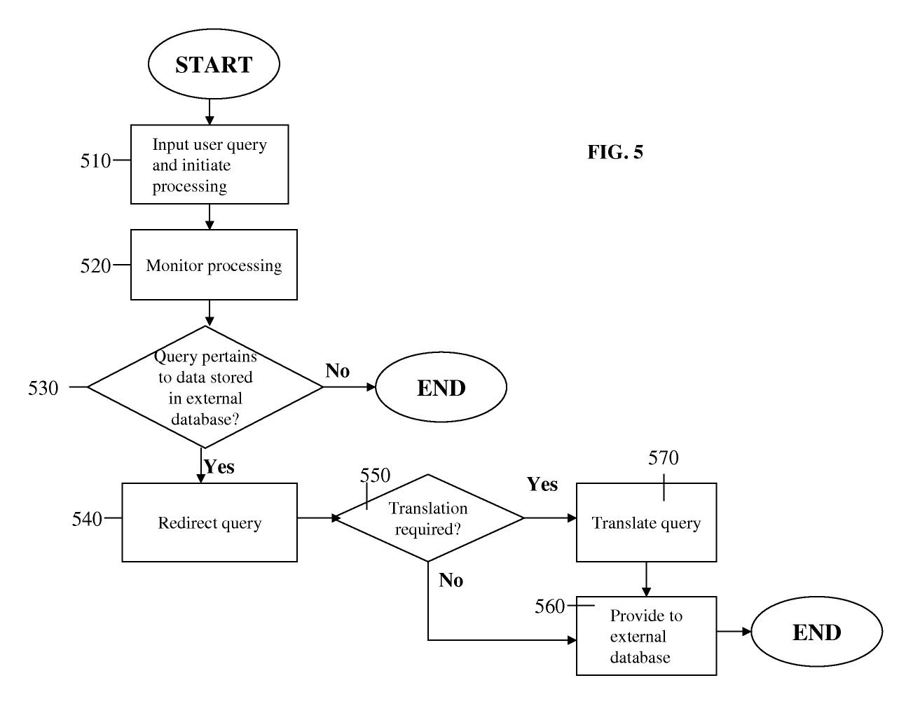

Reference is now made to FIG. 5 which is a simplified flowchart of a method for accessing data from a database, according to an embodiment of the present invention.

In 510 a user query is input, and the processing of the input query is initiated. In 520 the processing is monitored to determine if the query pertains to data stored in an external database. If it is determined in 530 that the query pertains to data stored in an external database. If yes, the query is redirected in 540 to the external database for processing, otherwise the method ends and processing continues without redirection. In 550 it is determined whether translation is necessary to overcome incompatibilities between the input query and the operation of the external database. If translation is not required, in 560 the query is provided to the external database. If translation is required, the input query is translated in 570 to a corresponding query and then provided to the external database in 560. Note that 550 may not require active decision-making, if translation of the query is always required or is always not required.

In some embodiments the method includes the further steps of receiving a result of the query from the external database and outputting the result. In some embodiments the received result is translated into a corresponding result suitable for further processing.

In some embodiments query monitoring 520 includes one or more of:

i. Determining whether a back-end data access pertains to data stored in the external database,

ii. Determining whether a data index access pertains to data stored in the external database,

iii. Determining whether a data element definition query pertains to data stored in the external database, and

iv. Determining whether the transaction conclusions pertain to data stored in the external database.

In some embodiments the method includes the further step of directing local queries for execution by the local back-end(s).

In some embodiments the translating in 570 includes retrieving the corresponding query from a translation table. The translation table is organized such that the retrieving prompts a function call external database in accordance with the corresponding translated query.

### Further Techniques

Following are description of possible issues which may arise and techniques devised to overcome these issues. Additional embodiments may include these techniques singly or in combination:
A) In the translation table embodiments each column in the translation table view is a function call. Some of the columns in the translation table are indexes and as such their database engine monitor functions will be called in the process of query resolution (also known as execution plan execution). The values passed in these function calls trigger accessing data from the external database efficiently, via respective indexes in the external database data store. For multi-column indexes and a typical execution plan, this process is inefficient unless there is some knowledge about which other index elements will be accessed in the course of executing the execution plan. To obtain this information, upon the first function access triggered by the translation table in resolution of a query, where the function called is related to a column that is part of one or more composite (multi-column) indexes, an internal table within the local front-end or local back-end is accessed that contains the execution plan and which may be analyzed to determine this information. The execution plan is then analyzed to determine whether the function access is part of usage of a wider composite index. The results of parsing of an execution plan may be cached to improve efficiency.
B) In the execution plan execution discussed above, it is required to return the set of row IDs relevant for the entire query. A very large number of IDs may be needed. To reduce storage space requirements in the local front-end, a single large set of row ids is stored in a separate “hidden” table (denoted herein the ROWID_POOL). All the views in the translation table which correspond to real tables in the external database join a table in the local front-end or local back-end with the ROWID_POOL table in the view's query translation process. Thus, the row IDs in the single dedicated translation table may be used for all tables in the external database without requiring each external database table to contain any rows at all.
C) Databases typically provide a method for interrogating table characteristics. To ensure that an application accessing the tables in the database engine receives appropriate results during the execution of Data definition queries (DDL), the Table data definition queries are caught by using triggers in the translation table. The DDLs are then forwarded to the translation unit and appropriate changes are made in the translation table.
D) Write operations into the database engine may trigger database engine monitor operations. Supporting data manipulation (DML) operations such as insert, update and delete are performed by forwarding them to the database engine for monitoring and letting the database engine manage the transaction and commit the changes when the user issues a commit. The DML operations may trigger interception unit and/or translation unit action through the incorporation of “INSTEAD OF” triggers on the views in the translation table.
E) Transaction virtualization:
   1. Upon a commit or a rollback from a database engine client, interception unit and/or translation unit action is triggered and the appropriate action is taken in the interception unit and/or translation unit. The interception unit and/or translation unit action may be triggered using a translation table view that is updated during any DML performed on the external database tables triggered by views. The translation table view has a trigger before update that may be used as a hook into the interception unit and/or translation unit.
   2. Rollbacks may be monitored by comparing the transactions known through interception unit and/or translation unit hooks and internal database tables with the local front-end's or local back-end's perception of running transactions. A timely background job that may be performed by the interception unit compares the interception unit's perception of running transactions to the local front-end's or local back-end's perception. Disparities imply rollbacks occurred.
   3. Typically, the appropriate connection to a 3^{rd} party database is retrieved using the database engine session and transaction ID and the command is forwarded to the 3^{rd} party back-end. To support sessions that are terminated unexpectedly, rollbacks may also be monitored by the interception unit and/or translation unit, as a background job that may ascertain that the transaction was closed.
   4. To support autonomous transactions, the interception unit and/or translation unit employs a different connection for each transaction into the external database so that multiple transactions may be run in parallel against a 3^{rd} party back-end even if it does not support autonomous transactions.

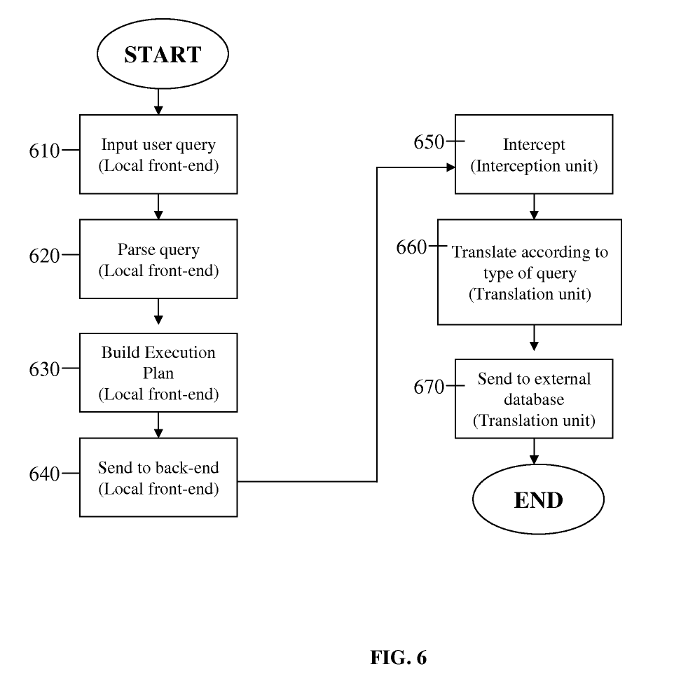

Reference is now made to FIG. 6 which is a simplified flowchart of a method for accessing data from a database, according to an exemplary embodiment of the present invention. Each step in FIG. 6 shows the database system element which performs the current operation.

The query is input in 610 (local front-end). In 620 the query is parsed (by local front-end). In 630 the Execution Plan is built (by local front-end). In 630 the commands in the execution plan are executed (by local front-end). Steps 640-670 are performed for each command. In 640 the commands is transferred to a back-end (by local front-end), and intercepted in 650 (by interception unit). The intercepted command is translated to the corresponding command is 660 (by translation unit). In 670 the translated command is sent to the external database (by translation unit).

Examples of translation operations which may be performed in 66 include: translate DML commands, DDL commands issue a trigger using “instead of” triggers on the View and modify the command, and if original table and command had triggers use “instead of” triggers to add an appropriate action.

The embodiments herein provide an interception and redirection mechanism which enable the use of a local front-end with an external database, even though the local front-end lacks the capabilities for direct interaction with the external database. The user is thus able to obtain a database system with expanded capabilities, and to enjoy the benefits of scalability, availability, geographical distribution and latency.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

It is expected that during the life of a patent maturing from this application many relevant database models, database protocols, query languages and databases interfaces will be developed and the scope of the term database model, database protocol, query language and databases interface is intended to include all such new technologies a priori. [

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non limiting fashion.

For clarity, the present exemplary embodiment of a database system is defined according to a syntax and protocol consistent with a DataOEM Oracle Express database, specifically a DataOEM Oracle Express database with ODCI (Oracle Data Cartridge Interface). The local front-end and interception unit (and in some embodiments translation unit) do not contain the application data but merely the structure and metadata of the database. It is to be understood that other embodiments are possible, including those based on protocols consistent with other currently available databases such as OpenLDAP, MySQL and SQLite.

Client applications connect to the Database engine by sending it SQL statements. Each SQL statement (Query or DML and maybe DDL in later stages) is intercepted by the interception unit, processed and forwarded to the external database. The external database returns the result to the Database engine (in some embodiments via the interception unit), which conveys them to the client application. The database engine is thus able to access the external data without the need to support all the Oracle specific syntax and functions.

### Supporting Queries

The database engine monitors processing, redirects queries and returns the data returned by the external database by using an ODCI to create an index implementation that holds the querying logic. The ODCI logic is applied when a select statement is triggered and to control the number of records that will be returned by the external database in response to the query.

The ODCI index requires that the index will return the ROWIDs of matching rows from the corresponding table. Each ROWID corresponds to a result row.

The translation table's schema consists of views which correspond to the original external database tables (as described in brief above). When a user executes a query, the appropriate view executes its select statement, and the ODCI index on the corresponding external database table is invoked.

### Supporting Data Manipulation Languages (DMLs)

DML operations such as insert, update and delete are performed by forwarding the DML operations to the database engine. The database engine manages the transaction and commits the changes when the user issues a commit.

The DML operations are caught using “INSTEAD OF” triggers on the views in the translation table, and are forwarded to the database engine via the interception unit.

In order to support autonomous transactions, a different connection to the external database is used for each transaction. Note that a single session may use several external database connections.

The external database connections are stored in an external connection pool. A connection is retrieved by a session and transaction ID. If there is no connection associated with those IDs, a connection is borrowed from the pool and kept in a map that has the IDs as the key.

When transaction is ended the connection is removed from the map and returned to the pool.

### Detailed Process Description

### 1) Schema Creation and DDL Handling

### A. Interface Description

DDLs are executed on the Database engine in a manner consistent with the Oracle standard.

### B) Major Module Internal Functions

The database engine builds the translation schema structure utilized by the translation unit from an existing schema structure by copying all the schema objects other than tables as is. For each external database table, a corresponding table is created in the translation table and a proper view is created consistently with the Oracle standard.

In order to support future DDL executions, the DDL triggers intercept DDLs on TABLE objects as follows:
For CREATE statements, in the AFTER trigger, the DDL is forwarded to database engine, the table is renamed and a view is created by the same name.
For ALTER statements, in the BEFORE trigger, the view is renamed to a temporary name and the original table is renamed back to the original name.

In the AFTER trigger the table and view is renamed back.
For DROP statements, in the BEFORE trigger, the DDL is forwarded to database engine, the view is dropped and the original table is renamed to the original name,

### 2) Supporting Queries

### A. Component Processing

For every table in the external database there is a corresponding table in the translation table. The translation table holds the data and a view with the same structure in an Oracle Express-compatible format.

To elaborate on the example presented above, for the following table in the external database:

TABLE 2

| | |
|---|---|
| 1. | create table EMP ( |
| 2. | ID number primary key, |
| 3. | FIRST_NAME varchar2(20), |
| 4. | LAST_NAME varchar2(50) |
| 5. | ) |

there is a corresponding view in the translation table having the following structure:

View 2

| Line no. | View definition |
|---|---|
| 1. | create view EMP as ( |
| 2. | select get_col_value_number(rowid, ‘EMP.ID’) as ID, |
| 3. | get_col_value_varchar2(rowid, |
| 4. | ‘EMP.FIRST_NAME’) as FIRST_NAME, |
| 5. | get_col_value_varchar2(rowid, |
| 6. | ‘EMP.LAST_NAME’) as LAST_NAME |
| 7. | from ROWID_POOL |
| | where index_operator(ROWID_POOL.ID) = 0 |
| | ) |

The function of each line in the view is as follows:
Line 1: Creating a view with the same name as the external database table.
Lines 2-4: Using an appropriate get_col_value_XXX function to simulate the columns of the table.
Line 5: Using a table named ROWID_POOL in the FROM clause. The table is filled with dummy rows and it functions only as a ROWID pool due to the ODCI index limitation in which the index must return only valid ROWIDs that exist in the table the index is based upon.
Line 6: Using a dummy “always true” Where clause to cause the database engine to use the defined index implementation.

### B. Interface Description

All the interfaces available in Oracle (e.g. SQL*Plus, ODBC, JDBC) are available for query execution by the database engine.

The claimed embodiments enable a user to utilize a local front-end to access data stored in an external database. The local front-end may be compatible with a known database such as Oracle. The user is thus able to perform data queries and other operations, for example using an Oracle-compatible interface and Oracle-compatible stored procedures, with an alternate external database having a different, and possibly superior, protocol and functionality.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A database system, comprising:
a first database having back-end functionality for data storage and database query execution;
a database front-end configured for processing user queries directed to a back-end of a second database, wherein said database front-end lacks capabilities for directly accessing said first database; and
an interception unit associated with said front-end and networked with said first database over a data network, configured for monitoring user queries under processing by said front-end to identify queries pertaining to data stored in said first database, and redirecting said identified queries to said database for execution, thereby to provide the functionality of said database front-end for data stored in said first database.

2. A database system according to claim 1, wherein said interception unit is further configured for receiving results of said redirected queries returned by said first database.

3. A database system according to claim 1, wherein said interception unit is configured to monitor back-end data access resulting from a user query and to determine whether said back-end data access pertains to data stored in said first database.

4. A database system according to claim 1, wherein said interception unit is configured to monitor data index access resulting from a user query and to determine whether said data index access pertains to data stored in said first database.

5. A database system according to claim 1, wherein said interception unit is configured to monitor data element definition queries resulting from a user query and to determine whether said data element definition queries pertain to data stored in said first database.

6. A database system according to claim 1, wherein said interception unit is configured to monitor transaction conclusions and to determine whether said transaction conclusions pertain to data stored in said first database.

7. A database system according to claim 1, further comprising a translation unit configured for translating an identified query into a corresponding query appropriate for execution by said first database.

8. A database system according to claim 7, wherein said translation unit is configured to resolve incompatibilities between said first database and said database front-end so as to translate said identified query into a query executable by said first database.

9. A database system according to claim 7, further comprising a translation table configured for storing translated queries, and arranged for storage such that said processing of a user query by said front-end retrieves a corresponding translated query from said translation table.

10. A database system according to claim 7, wherein said translation unit comprises a local data store configured for storing said translation table.

11. A database system according to claim 7, wherein said first database comprises a relational database having stored data organized as a table, wherein each row of said table comprises a relation of attribute values, and wherein said translation table is organized as a table of function calls such that accessing a location in said translation table prompts a function call to said corresponding translated query.

12. A database system according to claim 1, wherein said first database further comprises front-end functionality for processing user queries directed to said database.

13. A database system according to claim 1, wherein said second database comprises a single database back-end.

14. A database system according to claim 1, wherein said second database comprises a distributed database back-end.

15. A database system according to claim 1, further comprising a third database having back-end functionality for data storage and database query execution, wherein said database front-end lacks capabilities for directly accessing said third database, and wherein said interception unit is further networked with said third database over a data network, said interception unit being further configured for monitoring user queries under processing by said front-end to identify queries pertaining to data stored in said third database and for selecting one of said first and third databases for redirection of an identified query.

16. A database engine on an electronic processor, the database engine comprising:
an execution unit, configured for processing user queries;
a user interface associated with said execution unit, configured for inputting user queries and providing said queries to said execution unit for processing; and
an interception unit associated with said execution unit, configured for monitoring queries being processed by said execution unit to identify queries pertaining to data stored in an external database, wherein said execution unit lacks capabilities for directly accessing data stored in said external database, and redirecting said identified queries for execution by said external database.

17. A database engine according to claim 16, wherein said interception unit is configured to monitor back-end data access resulting from a user query and for determining whether said back-end data access pertains to data stored in said external database.

18. A database engine according to claim 16, wherein said interception unit is configured to monitor data index access resulting from a user query and for determining whether said data index access pertains to data stored in said external database.

19. A database engine according to claim 16, wherein said interception unit is configured to monitor data element definition queries resulting from a user query and for determining whether said data element definition queries pertain to data stored in said external database.

20. A database engine according to claim 16, wherein said interception unit is configured to monitor transaction conclusions and for determining whether said transaction conclusions pertain to data stored in said external database.

21. A database engine according to claim 16, wherein said interception unit is further configured for translating said identified queries into respective corresponding queries for execution by said external database, and for providing said translated queries to said external database.

22. A database engine according to claim 16, wherein said interception unit and said external database are configured for communication over a network.

23. A method for accessing data from a database comprising:
inputting a query and initiating processing of said query by a first database;
monitoring said processing to determine if said query pertains to data stored in a second database, wherein said first database lacks capabilities for directly accessing data stored in said second database; and
if said query pertains to data stored in said second database, redirecting said query to said second database for execution.

24. A method according to claim 23, further comprising:
receiving a result of said query from said second database; and
completing processing of said query in accordance with said result.

25. A method according to claim 23, wherein said redirected query is incompatible with said second database, and further comprising translating said redirected query into a corresponding query compatible with said second database.

26. A method according to claim 25, wherein said translating comprises retrieving said corresponding query from a translation table, said translation table being organized such that said retrieving prompts a function call to said second database in accordance with said corresponding translated query.

27. A method according to claim 25, further comprising translating a result of said query compatible with said second database into a corresponding result suitable for further processing.

28. A method according to claim 23, wherein said monitoring comprises determining whether a back-end data access pertains to data stored in said second database.

29. A method according to claim 23, wherein said monitoring comprises determining whether a data index access pertains to data stored in said second database.

30. A method according to claim 23, wherein said monitoring comprises determining whether a data element definition query pertains to data stored in said second database.

31. A method according to claim 23, wherein said monitoring comprises determining whether a transaction conclusion pertains to data stored in said second database.
